(19) United States
(12) Patent Application Publication
(10) Pub. No.: US 2022/0072840 A1
(43) Pub. Date: Mar. 10, 2022

(54) INTRUSION RESISTANT THERMAL LAMINATING FILM

(71) Applicant: D&K International Inc., Elk Grove Village, IL (US)

(72) Inventor: Karl Richard Singer, Barrington Hills, IL (US)

(21) Appl. No.: 17/017,323

(22) Filed: Sep. 10, 2020

(51) Int. Cl. B32B 27/36; B32B 27/08; B32B 27/16; B32B 27/30; B32B 7/027; B32B 7/12; B32B 27/32; B32B 38/00

(52) U.S. Cl. CPC B32B 27/36; B32B 2310/14; B32B 27/16; B32B 27/304; B32B 7/027; B32B 7/12; B32B 27/308; B32B 27/32; B32B 38/145; B32B 2307/516; B32B 2307/518; B32B 2367/00; B32B 2310/0831; B32B 2307/581; B32B 2250/24; B32B 2307/70; B32B 2307/31; B32B 2425/00; B32B 2305/347; B32B 2327/06; B32B 27/08

(57) ABSTRACT

Disclosed herein is an intrusion resistant thermal laminating film having a first multilayer structure of a polyester polymer layer and an ethylene methyl acrylate copolymer layer adhered thereto. The first multilayer structure is exposed to UV radiation for an effective period. A first adhesive layer is on the first multilayer structure and is an ethylene vinyl acetate copolymer or an ethylene ethyl acrylate copolymer. The film also has a printed layer of a polyolefin or a polyvinyl chloride attached to the adhesive layer. The film has high clarity and is free of a primer. The printed layer cannot be separated from the first multilayer structure without destroying the film. The film exhibits no signs of orange peel.

### CROSS-REFERENCE TO RELATED APPLICATIONS

None.

### FEDERALLY SPONSORED RESEARCH OR DEVELOPMENT

N/A

### FIELD OF THE INVENTION

Intrusion resistant thermal laminating films for forming ID cards and secure documents to prevent or deter counterfeiting and forgery of written material within the film.

### DESCRIPTION OF THE PRIOR ART

Intrusion resistant films are required to prepare secure documents and ID cards, for example, that cannot be altered by counterfeiters and forgers. At the core of secure documents and ID cards is a polymeric layer bearing printed information. An optically clear external layer covering the printed layer allows for viewing of the printed material. If a film is not intrusion resistant, a counterfeiter can peel the external layer from printed layer and alter the printed material. Those intent on altering the printed information can resort to techniques, typically using a digitally controlled hot plate to delaminate the film to expose the printed material to allow for alteration. Once altered, the external layers are reapplied to the printed sheet to appear original. U.S. Pat. No. 9,222,004 discloses an intrusion resistant film having a substrate of polycyclohexylenedimethylene terephthalate coated with a thermal adhesive of a blend of one or more alkyl acrylate or alky acrylic acid copolymers and low-density polyethylene. Suitable alkyl acrylic acid copolymers include ethylene acrylic acid, ethylene methacrylic acid, and combinations thereof. The '222 patent discloses that most thermal laminating films will easily delaminate because the substrate is an oriented polyester terephthalate with a high crystallinity.

### SUMMARY OF THE INVENTION

Disclosed herein is an intrusion resistant thermal laminating film having a first multilayer structure of a polyester polymer layer and an ethylene methyl acrylate copolymer (EMA) layer adhered thereto. The multilayer structure having been exposed to UV radiation for an effective period to ensure the layers to not delaminate. A first adhesive layer is on the first multilayer structure. The first adhesive layer is an ethylene vinyl acetate copolymer (EVA) or an ethylene ethyl acrylate copolymer (EEA). A printed layer of a polyolefin or a polyvinyl chloride is attached to the first adhesive layer. The film has high optical clarity and the EMA layer cannot be separated from the polyester layer without destroying the film. The film exhibits no signs of orange peel and is free of a primer.

Also disclosed herein is a method of forming an intrusion resistant thermal laminating film. The method includes: (1) providing a first web of a polyester sheet material; (2) applying an ethylene methyl acrylate copolymer or an ethylene ethyl acrylate copolymer (EEA) to the polyester sheet to form a first multilayer structure; (3) exposing the first multilayer structure to UV light for an effective period; (4) applying a first adhesive to the EMA layer or EAA layer by extrusion coating, the first adhesive is an ethylene vinyl acetate copolymer (EVA) or an ethylene ethyl acrylate copolymer (EEA); (5) providing a printed sheet of a polymeric material; and, (6) attaching the printed sheet to the first adhesive.

Other features and advantages of the invention will be apparent from the following specification taken in conjunction with the following Figures.

### BRIEF DESCRIPTION OF THE FIGURES

To understand the present invention, it will now be described by way of example, with reference to the accompanying drawings and attachments in which:

FIG. 1 is a schematic diagram of a tandem extrusion line of the present invention.

FIG. 2 is a cross-sectional view of a two-layered polymeric structure.

FIG. 3 is a cross-sectional view of a three-layered polymeric structure.

FIG. 4 is a cross-sectional view of a four-layered polymeric structure.

FIG. 5 is a cross-sectional view of a seven-layered polymeric structure.

FIG. 6 is a diagrammatic view of a laminating machine.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

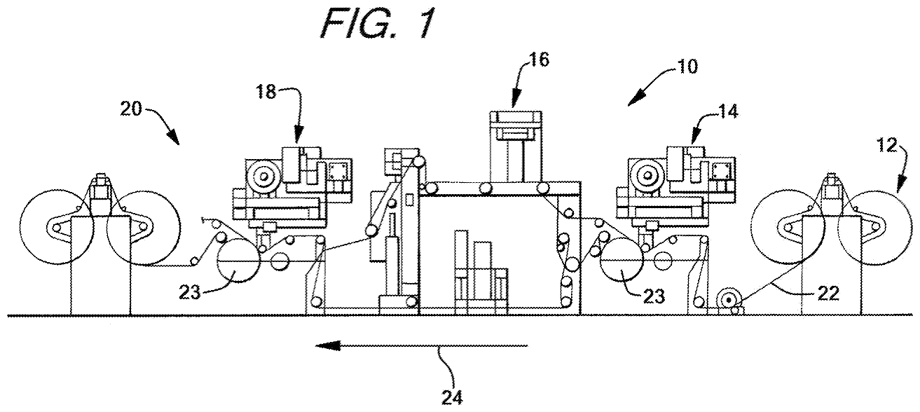

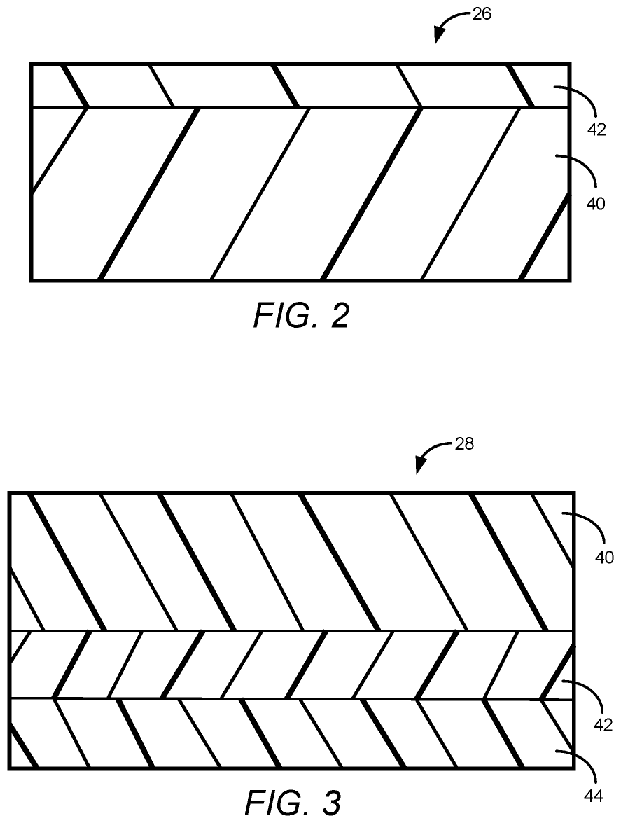

FIG. 1 shows a tandem extrusion line 10 having a supply roll 12 of a polyester sheet material, a first extruder 14, a UV light exposure station 16, a second extruder 18, and a storage roll 20. Using a series of rollers, a web 22 of the polyester is pulled in the direction of arrow 24 into the first extruder 14 where an ethylene methacrylate copolymer (EMA) is applied on an upper surface of the polyester web 22 to form a two-layered polymeric structure 26 shown in FIG. 2. The two-layered structure 26 is then moved across a chill roll 23 to the UV light exposure station where the two-layered structure 26 is exposed to UV light at a frequency from about 150 nm to about 400 nm and most preferably about 400 nm for a period of 1 second. The UV exposure station, in one preferred form, has three mercury vapor lamps each at a wavelength of about 400 nm, with a power of 400 watts per inch and is 60 inches long.

No photoinitiators are required in the process. Also, no primers were used which resulted in a film that shows no signs of orange peel. Orange peel is a bumpy texture that resembles the skin of an orange and is undesirable in laminating films.

FIG. 2 shows the two-layered structure 26 having a polyester layer 40 and an ethylene methyl acrylate copolymer (EMA) layer or an ethylene ethyl acrylate copolymer (EEA) layer. Suitable polyesters include polyethylene terephthalate (PET), ethylene glycol modified polyethylene terephthalate, polycyclohexylene dimethylene terephthalate (PCTA), and glycol modified polycyclohexylene dimethylene terephthalate. Most preferably, the polyester layer is uniaxially oriented or biaxially oriented. Most preferably, the polyester is a biaxially oriented PET (OPET). The polyester web is a sheet material with a thickness of from about 1 mil to 10 mils. The polyester layer can be printed on prior to use with textual or graphical information. Suitable EMA copolymers include those sold by Kolm Polymers, Ltd. under the trademark EMAC having a methyacrylate (MA) content from 18%-22%, and most preferably EMAC 6 with a 20% MA content. The EMA layer 42 has a thickness of from about 1 mil to about 4 mils. The two-layered film has a high clarity as measured by light transmission (ASTM D 1003) of 85% or higher or 89% or higher. The UV-irradiated two-layer structure 26 is moved to the second extruder 18 where an adhesive is applied onto the EMA layer or the EEA layer to form a third layer 44 (FIG. 3). In one preferred form of the invention, the adhesive is an ethylene vinyl acetate copolymer (EVA) having a vinyl acetate content of from 10% to 28% or an ethylene ethyl acrylate copolymer (EEA) with an ethyl acrylate content of from 10% to 28% or a combination of the two. This forms a three-layered polymeric structure 28 shown in FIG. 3. One suitable EVA is sold by Celanese under the trademark ATEVA® and more preferably ATEVA® 1615. One suitable EEA is sold by DuPont under the trademark ELVALOY® and more preferably ELVALOY® AC 2618.

The three-layer polymeric structure 28 is contacted with a second chill roll 23 and is wound up on the storage roll 20 for storage or shipment. It is also contemplated the take up roll can be replaced by additional extrusion stations or laminating stations to add additional layers to the three-layered polymeric structure.

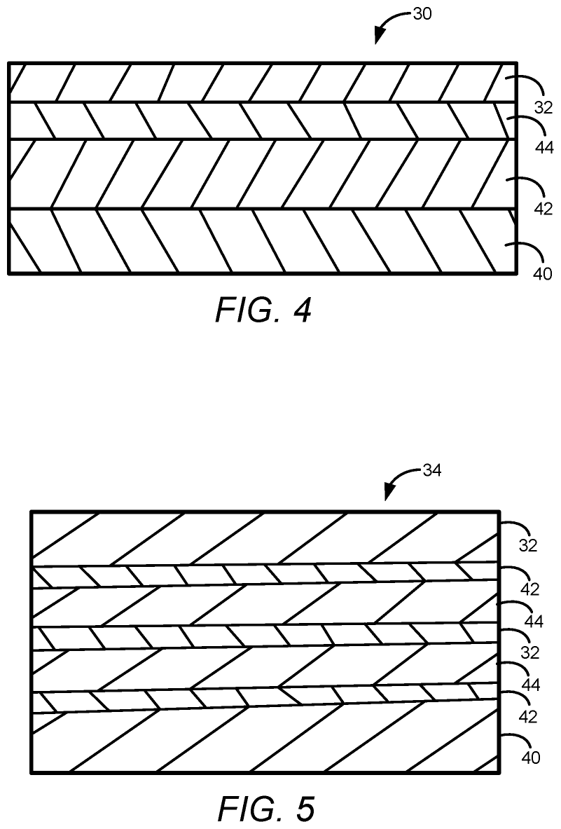

FIG. 4 shows the three-layered structure 28 attached to a polymeric layer 30 bearing printed material to form a four-layered structure 30. The printed layer 32 is a polymeric material and, in one preferred form, is a polyolefin or a polyvinyl chloride (PVC). The printed layer 30 has a thickness of from about 4 mils to about 20 mils. Suitable polyolefins are formed from monomers having from two to twelve carbons and include, for example, ethylene, propylene, butene, hexene, septene, and octene. The polyolefins can be homopolymers, copolymers, and terpolymers. The polyolefins can include low-density polyethylene, medium-density polyethylene, high-density polyethylene, ultra-low density polyethylene, linear low density polyethylene, polypropylene, poly(propylene ethylene) copolymers, and other polyolefins well known to a person having ordinary skill in the art. The printed layer 30 can include a wide variety of textual, artistic, numeric information applied to the layer by hand or machine. One method of attaching these layers includes the use of heat alone or heat and pressure in a laminating process to permanently attach the layers so they cannot be separated from one another without leaving signs of tampering or destroying the layered structure i.e., intrusion resistant or tamper evident.

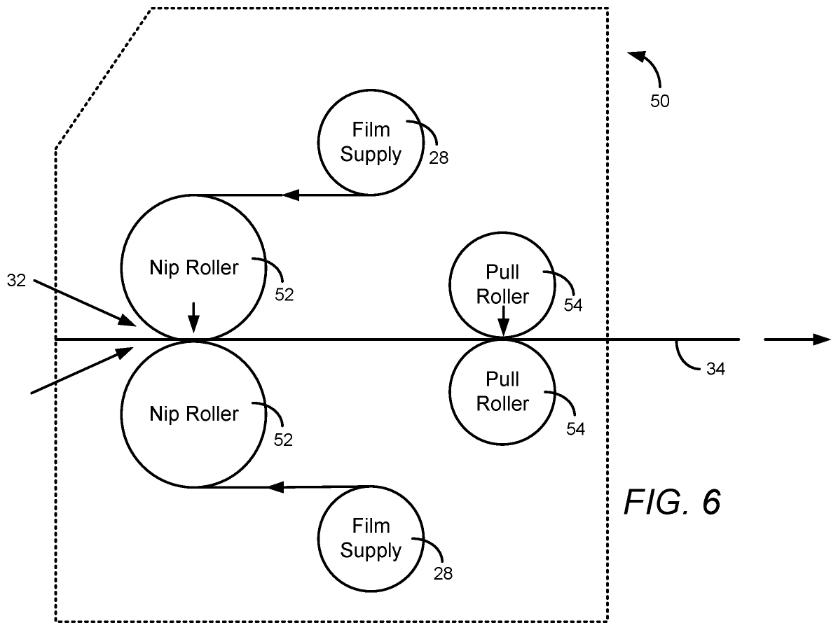

FIG. 5 shows a film structure with seven layers 34. Two three-layered structures 28 sandwich the printed layer 32 to form a double laminated film. In one preferred form, the seven-layer film is symmetrical about the printed layer. The seven-layered structure 34 can be assembled using heat alone or heat and pressure in a lamination process shown in FIG. 6.

FIG. 6 shows a laminating machine or laminating station 50 having two supply rolls of the three-layer structure 28, two nip rollers 52, and two pull rollers 54. A printed layer of film 32 is pulled with the pull rollers 54 between the two nip rollers 52 where two three-layered structures 28 are applied to opposite sides of the printed film layer 32 to form a seven layer structure 34 that exits the laminating machine for further processing or for storage on a roll.

### Example

A four-layer film was constructed as described above having the following layer structure PET/EMA/EVA/polyolefin based synthetic paper (TESLIN®). The film was cut into four 10 mm wide test sections and subjected to peel strength testing. An INSTRON® tester was connected to the polyolefin layer and the PET/EMA/EVA layer and one layer was pulled at a rate of 254 mm/min at a 90° angle. The film could not be delaminated without destroying the film. Samples of the film were also subjected to a Polaroid Environment Test. Samples of the film were placed in a pressure cooker above, and not immersed, in 225 ml of water. The pressure cooker was placed in an oven at 71° C. for five days. Next the samples were placed in a gallon paint can along with 20 grams of ASTM C778 sand and 30 ml of distilled water. The gallon can was shook for three hours using a commercial paint shaker. The samples were removed, washed, and dried and visually examined. The samples showed some signs of rounded, worn or abraded corners, but no samples showed any signs of delamination. The film had a smooth surface and showed no signs of orange peel. The film is free of a primer which can cause clouding of the film.

Many modifications and variations of the present invention are possible in light of the above teachings. It is, therefore, to be understood within the scope of the appended claims the invention may be protected otherwise than as specifically described.

I claim:

1. An intrusion resistant thermal laminating film comprising:
a first multilayer structure of a polyester polymer layer and an ethylene methyl acrylate copolymer layer adhered thereto, the first multilayer structure having been exposed to UV radiation for an effective period;
a first adhesive layer on the first multilayer structure, the first adhesive layer is an ethylene vinyl acetate copolymer (EVA) or an ethylene ethyl acrylate copolymer (EEA);
a printed layer of a polyolefin or a polyvinyl chloride attached to the first adhesive layer; and,
the film having high clarity, the printed layer cannot be separated from the multilayered structural layer without destroying the film, the film shows no signs or orange peel, and is free of a primer.

2. The film of claim 1 wherein the polyester polymer layer is selected from the group consisting of polyethylene terephthalate, ethylene glycol modified polyethylene terephthalate, polycyclohexylene dimethylene terephthalate, and glycol modified polycyclohexylene dimethylene terephthalate.

3. The film of claim 1 wherein the polyester polymer layer is uniaxially oriented or biaxially oriented.

4. The film of claim 3 wherein the polyester layer is polyethylene terephthalate.

5. The film of claim 1 wherein the first multilayer structure has a thickness from 2 mils to 10 mils.

6. The film of claim 5 wherein the adhesive layer has a thickness from 1 mil to 4 mils.

7. The film of claim 1 further comprising a second multilayer structure adhered to the printed layer on a side opposite of the first multilayer structure.

8. The film of claim 7 wherein the second multilayer structure comprises a polyester polymer layer and an ethylene methyl acrylate copolymer layer adhered thereto, the second multilayered structure having been exposed to UV radiation for an effective period.

9. The film of claim 8 further comprising a second adhesive layer adhering the second multilayer structure to the printed layer.

10. The film of claim 1 wherein the second multilayer structure has a thickness from 1 mil to 6 mils.

11. A method of forming an intrusion resistant film comprising:
providing a first web of a polyester sheet material;
applying an ethylene methyl acrylate copolymer (EMA) or an ethylene ethyl acrylate copolymer (EEA) to the polyester sheet to form a first multilayer structure;
exposing the first multilayer structure to UV light for an effective period;
applying a first adhesive to the EMA layer or EAA layer by extrusion coating, the first adhesive is an ethylene vinyl acetate copolymer (EVA) or an ethylene ethyl acrylate copolymer (EEA);
providing a printed sheet of a polymeric material; and,
attaching the printed sheet to the first adhesive.

12. The method of claim 11 further comprising:
providing a second web of a polyester material;
applying an ethylene methyl acrylate copolymer (EMA) or an ethylene ethyl acrylate copolymer (EEA) to the polyester sheet to form a second multilayer structure;
exposing the second multilayer structure to UV light for an effective period;
applying a first adhesive to the EMA layer or the EAA layer by extrusion coating, the first adhesive is an ethylene vinyl acetate copolymer (EVA) or an ethylene ethyl acrylate copolymer (EEA); and,
attaching the second multilayer structure to the printed sheet on a side opposite of the first multilayer structure.

13. The method of claim 12 wherein the polyester polymer layer is selected from the group consisting of polyethylene terephthalate, ethylene glycol modified polyethylene terephthalate, polycyclohexylene dimethylene terephthalate, and glycol modified polycyclohexylene dimethylene terephthalate.

14. The method of claim 12 wherein the polyester polymer layer is uniaxially oriented or biaxially oriented.

15. The method of claim 14 wherein the polyester layer is a polyethylene terephthalate.

16. The method of claim 12 wherein the first multilayer structure has a thickness from 1 mil to 4 mils.

17. The method of claim 16 wherein the first adhesive layer has a thickness from 1 mil to 6 mils.

18. The method of claim 12 further comprising exposing the first web of polyester to a corona discharge process.

19. The method of claim 12 wherein the film is free of a primer.

20. The method of claim 12 wherein the film has exhibits no signs of orange peel.
